(19) United States
(12) Patent Application Publication
(10) Pub. No.: US 2011/0058706 A1
(43) Pub. Date: Mar. 10, 2011

(54) SYSTEM AND METHOD FOR VIDEO DETECTION OF SMOKE AND FLAME

(75) Inventors: Ziyou Xiong, Wethersfield, CT (US); Hongcheng Wang, Vernon, CT (US); Rodrigo E. Caballero, Crystal lake, IL (US); Pei-Yuan Peng, Ellington, CT (US); Alan Matthew Finn, Hebron, CT (US)

(73) Assignee: UTC FIRE & SECUNITY

(21) Appl. No.: 12/736,749

(22) PCT Filed: May 8, 2008
(86) PCT No.: PCT/US2008/005962

§ 371 Date: Nov. 5, 2010

(51) Int. Cl. G06K 9/00

(52) U.S. Cl. 382/100

(57) ABSTRACT

A video recognition system detects the presence of fire based on video data provided by one or more video detectors. The video recognition system is operable to calculate a first flicker feature with respect to a first set of frame data and a second flicker feature with respect to a second set of frame data. The video recognition system combines the first flicker feature and the second flicker feature to generate an accumulated flicker feature. The video recognition system defines, based on the accumulated flicker feature, a flicker mask that represents a dynamic region of the fire. Based on the defined flicker mask, the video recognition system determines whether the video data indicates the presence of fire.

### BACKGROUND

The present invention relates generally to computer vision and pattern recognition, and in particular to video analysis for detecting the presence of fire.

The ability to detect the presence of fire provides for the safety of occupants and property. In particular, because of the rapid expansion rate of a fire, it is important to detect the presence of a fire as early as possible. Traditional means of detecting fire include particle sampling (i.e., smoke detectors) and temperature sensors. While accurate, these methods include a number of drawbacks. For instance, traditional particle or smoke detectors require smoke to physically reach a sensor. In some applications, the location of the fire or the presence of heating, ventilation, and air conditioning (HVAC) systems prevents smoke from reaching the detector for an extended length of time, allowing the fire time to spread. A typical temperature sensor requires the sensor to be located physically close to the fire, because the temperature sensor will not sense a fire until a sufficient amount of the heat that the fire produces has spread to the location of the temperature sensor. In addition, neither of these systems provides as much data as might be desired regarding size, location, or intensity of the fire.

Video detection of a fire provides solutions to some of these problems. A number of video content analysis algorithms for detecting flame and smoke are known in the prior art. For example, some of these prior art methods extract a plurality of features that are used to identify a static, core region of fire and a dynamic, turbulent region of the fire. Based on the identified regions, the algorithms determine whether the video data indicates the presence of fire. Additional processing power is required for each feature extracted by the algorithm. It would therefore be beneficial to develop a system that minimizes the number of features that must be extracted, while still accurately detecting the presence of fire.

### SUMMARY

Described herein is a method of detecting the presence of fire based on video input. The method includes acquiring video data comprised of individual frames and organized into a plurality of frame data sets. A plurality of flicker features corresponding to each of the plurality of frame data sets is calculated, and the plurality of flicker features are combined to generate an accumulated flicker feature. Based on the accumulated flicker feature, the method defines a flicker mask representing a dynamic region of a fire, and determines, based on the defined flicker mask, whether the video data is indicative of the presence of fire.

In another aspect, a system for detecting the presence of flame or smoke comprises a video recognition system operably connected to receive video data comprising a plurality of individual frames from one or more video devices and to provide an output indicating the presence of fire in the received video data. The video recognition system includes a frame buffer, a flicker feature calculator, a flicker feature accumulator, a flicker mask, and decisional logic. The frame buffer is operably connectable to receive video comprised of a plurality of individual frames and to store the received video data. The flicker feature calculator calculates a plurality of flicker features, each flicker feature being associated with one of a plurality of frame data sets. The flicker feature accumulator combines the plurality of flicker features calculated with respect to each of the plurality of frame data sets to generate an accumulated flicker feature. The flicker mask generator defines a flicker mask based on the accumulated flicker feature, wherein the flicker mask represents a dynamic portion of a potential fire. The decisional logic determines based on the defined flicker mask whether the video data is indicative of fire and generate an output to that effect.

In another aspect, a system for detecting the presence of fire based on video analysis is described. The system includes means for acquiring video data comprised of individual frames and organized into a plurality of frame data sets, each frame comprised of a plurality of pixels. The system further includes means for storing the acquired video data as a plurality of frame data sets, means for calculating a plurality of flicker features corresponding to pixels in each of the plurality of frame data sets, and means for combining the plurality of flicker features calculated with respect to each of the plurality of frame data sets to generate an accumulated flicker feature. The system further includes means for defining a flicker mask based on the accumulated flicker feature, wherein the flicker mask represents a potentially dynamic region of fire. The system further includes means for determining the presence of fire in the acquired video data based on the defined flicker mask, and means for generating an output based on the resulting determination of whether the acquired video data is indicative of the presence of fire.

### BRIEF DESCRIPTION OF THE DRAWINGS

FIG. 1 is a functional block diagram of a video detector and video recognition system of the present invention.

FIG. 2 is a diagram illustrating the analysis performed by the video recognition system of the present invention.

### DETAILED DESCRIPTION

Prior art methods of detecting the presence of fire calculate one or more features that are used to identify “visual signatures” indicative of fire. To prevent false alarms, prior art methods typically extract features to identify both a static and dynamic region of the fire. For instance, color features may be used to identify the core region of a fire, and flickering features may be used to identify a dynamic region of fire. The presence of fire is determined based on the identification of both the static and dynamic regions.

The present invention describes a novel method of identifying the presence of fire that employs an accumulated flicker feature that is used to accurately identify the dynamic region of a fire. A static region of the fire may then be determined based on the boundary of the identified dynamic region. Thus, the present invention does not require the calculation of additional features to identify the static region. Traditional flicker features are temporal features that are calculated with respect to a plurality of frames of data. The accumulated flicker feature calculates flicker features over a plurality of frames of data, but then also accumulates the calculated flicker features to generate an accumulated flicker feature. The accumulation of flicker features results in the generation of a well-defined dynamic region (i.e., flicker region).

The term ‘fire’ is used throughout the description to describe both flame and smoke. Where appropriate, specific embodiments are described in which analysis is directed toward specifically detecting the presence of either flame or smoke.

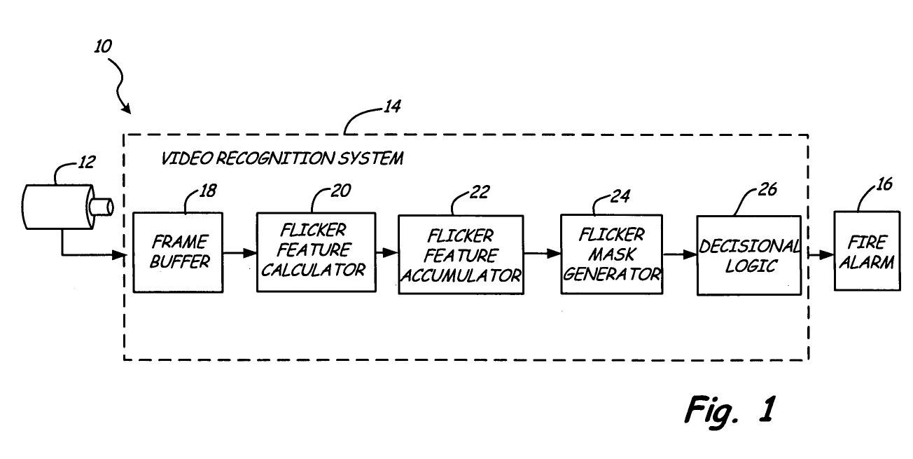

FIG. 1 is a block diagram of video-based fire detection system 10 of the present invention, which includes one or more video detectors 12, video recognition system 14, and fire alarm system 26. Video images captured by video detector 12 are provided to video recognition system 14, which includes hardware and software necessary to analyze the video data. The provision of video by video detector 12 to video recognition system 14 may be by any of a number of means, e.g., by a hardwired connection, over shared wired network, over a dedicated wireless network, over a shared wireless network, etc. The provision of signals by video recognition system 14 to fire alarm 16 may be by any of a number of means, e.g., by a hardwired connection, over a shared wired network, over dedicated wireless network, over a shared wireless network, etc.

Video detector 12 may be a video camera or other image data capture device. The term video input is used generally to refer to video data representing two or three spatial dimensions as well as successive frames defining a time dimension. In an exemplary embodiment, video detector 12 may be broadly or narrowly responsive to radiation in the visible spectrum, the infrared spectrum, the ultraviolet spectrum, or a combination of these spectrums. The video input is analyzed by video recognition system 14 using computer methods to calculate an accumulated flicker feature that is used to identify a dynamic portion of fire. Based on the identification of this dynamic region, decisional logic can be used to determine whether the video data is indicative of the presence of a fire.

Video recognition system 14 includes frame buffer 18, flicker feature calculator 20, flicker feature accumulator 22, flicker mask generator 24, and decisional logic 26. Some or all of these components may be implemented by a combination of hardware and software employed by video recognition system 14. For instance, such as a system may include a microprocessor and a storage device, wherein the microprocessor is operable to execute a software application stored on the storage device to implement each of the components defined within video recognition system 14.

Video detector 12 captures a number of successive video images or frames and provides the frames to video recognition system 14. Frame buffer 18 stores the video images or frames acquired by video recognition system 14. Frame buffer 18 may retain one frame, every successive frame, a subsampling of successive frames, or may only store a certain number of successive frames for periodic analysis. Frame buffer 18 may be implemented by any of a number of means including separate hardware (e.g., disk drive) or as a designated part of computer memory (e.g., random access memory (RAM)).

Flicker feature calculator 20 calculates a flicker feature associated with the frames stored by frame buffer 18. In general, flicker features are temporal features that evaluate the change in color or intensity of individual pixels over time (i.e., over a number of successive video frames). In particular, the flicker feature is typically described in terms of a detected frequency, with different frequencies known to be indicative of either flame or smoke. For instance, experimental results indicate that flame has a characteristic flicker up to approximately fifteen Hertz (Hz). Experimental results also indicate that smoke has a characteristic flicker up to three Hz. A variety of well-known methods may be employed for calculating a flicker feature, including Discrete Fourier Transform (DFT), Fast Fourier Transform (FFT), Wavelet Transform, Mean Crossing Rate (MCR), or incremental DFT, etc. The discrete sine and cosine transforms may also be used in place of the more general Fourier Transform. In an exemplary embodiment, flicker feature calculator 20 calculates flicker features using a mean crossing rate (MCR) over N frames stored in the frame buffer. The process is described by the following equation.

$$MCR = \frac{1}{2} {\sum }_{m = 1}^{N - 1} \vert sgn [ x ( m + 1 ) ] - sgn [ x ( m ) ] \vert \\ wherein sgn [ x ( m ) ] = \{ \begin{matrix}1 & x ( m ) > mean ( x ) \\ - 1 & otherwise\end{matrix} \qquad ( 1 )$$

Flicker feature accumulator 22 combines the flicker features calculated by flicker feature calculator 20 to generate an accumulated flicker feature. For instance, a flicker feature generated with respect to a first set of frames is combined by accumulator 22 with a flicker feature generated with respect to a second set of frames. In this way, the accumulated flicker feature is accumulated over time. In an exemplary embodiment, flicker feature accumulator 22 combines flicker features by summing the flicker feature values calculated with respect to individual pixels over successive sets of frames. In another exemplary embodiment, flicker feature accumulator 22 employs a logical ‘OR’ operation to combine flicker features calculated with respect to individual pixels over successive sets of frames. In this embodiment, flicker features having a higher frequency are selected as representative of the flicker associated with the particular pixel. Depending on environmental and desired system performance, many mathematical or statistical operations may be beneficially employed to combine flicker features.

Flicker mask generator 24 groups together neighboring pixels identified by the accumulated flicker feature as potentially indicating the presence of fire (e.g., either flame or smoke) to generate a flicker mask. The flicker mask represents the region within the field of view of video detector 12 that illustrates the characteristic flicker indicative of the turbulent or dynamic portion of a fire. In an exemplary embodiment, the flicker mask is defined after all flicker features have been combined into an accumulated flicker feature. For example, flicker features are extracted for a plurality of sets of frame data within a buffer. Upon reaching the end of the buffer, the individual flicker values are combined to generate the accumulated flicker value and a flicker mask is generated therefrom.

As described above, a fire typically consists of a static core of a fire surrounded by a turbulent, dynamic region. Prior art methods of detecting fire have relied on extracting features used to identify both the static core and the dynamic, turbulent region. The present invention defines an accumulated flicker feature that is used to identify the dynamic region, but does not require the extraction of additional features to define the static region. Rather, the present invention defines the static core region based on the boundary of the well-defined flicker mask. For instance, the static region may be identified based on a boundary associated with the flicker mask. The boundary may be defined as an interior boundary or border associated with the flicker mask, such that the static region is defined as being interior to the flicker mask.

Based on the defined flicker mask, decisional logic 26 determines whether the video data indicates the presence of fire. In an exemplary embodiment, the geometry associated with the identified flicker mask is analyzed by decisional logic 26 to detect the presence of fire. This may include comparing the geometry of the identified flicker mask with the geometry of the static region defined by the boundary of the identified flicker mask. In an exemplary embodiment, decisional logic 26 employs learned models (e.g., fire-based models and non-fire based models) to determine whether the video data is indicative of the presence of fire. The models may include a variety of examples of video data illustrating both the presence of fire and the lack of fire. In an exemplary embodiment, the models are comprised of a library of actual images representing fire conditions and non-fire conditions, and may include identification of static and dynamic regions associated with each image. Decisional logic 26 determines the presence of fire based on whether the defined regions (i.e., the dynamic region and static region) more closely resemble the fire-based models or the non-fire-based models.

In other exemplary embodiments, decisional logic 26 may employ support vector machine (SVM), a neural net, a Bayesian classifier, a statistical hypothesis test, a fuzzy logic classifier, or other well-known classifiers capable of analyzing the relationship between the dynamic region defined by the flicker mask and the static region defined by the boundary of the flicker mask.

Video recognition system 14 generates an output that is provided to alarm system 16. The output may include a binary representation of whether the presence of fire has been detected within the video data. In an exemplary embodiment, the output may also include data indicative of the size and location of the fire. The output may also include the video data received from the video detector and features calculated with respect to the video detector. The output may also be indicative of the certainty of the presence of fire.

Alarm system 16 receives the output provided by video recognition system 14. In an exemplary embodiment, alarm system 16 may include traditional fire alarms, including audio and visual alarms indicating to occupants and local fire-fighters the presence of a fire. In other exemplary embodiments, alarm system 16 may include a user interface in which the detected presence of a fire alerts a human operator. In response, the human operator may review video data provided by video recognition system 14 to determine whether a fire alarm should be sounded.

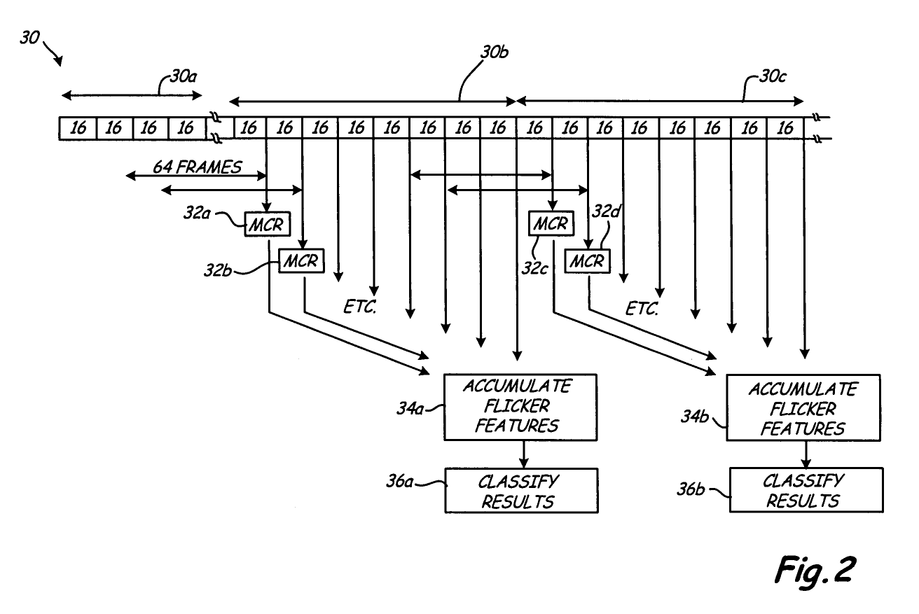

FIG. 2 is a diagram that illustrates graphically an exemplary embodiment of the functions performed by video recognition system 14 in analyzing video data. In particular, FIG. 2 illustrates the accumulation of flicker values to generate an accumulated flicker value. In this embodiment, frame buffer 30 is divided into a plurality of sixteen frame groups. Individual flicker values are calculated based on sets of frame data, each frame data set consisting of sixty-four frames of video data. An accumulated flicker value is generated by combining the individual flicker values generated with respect to a particular buffer of video data.

In this embodiment, frame buffer 30 is a rolling buffer capable of storing at least one-hundred twenty-eight frames of data. The most recently acquired frame data replaces the oldest in a first in, first out (FIFO) storage system. To initialize the system, at least sixty-four frames of data must be stored to frame buffer 30, as illustrated by buffer region 30a. Initializing the system ensures that the first flicker value is calculated with respect to sixty-four frames of video data.

Following the initialization of frame buffer 30, flicker values are calculated with respect to the previously stored sixty-four frames of data. In this exemplary embodiment, mean crossing rates (MCR) are employed to calculate the flicker associated with each set of frame data. For example, flicker value 32a is calculated with respect to a portion of the initialization buffer 30a and the first sixteen frames of frame buffer portion 30b. The sixty-four frames of data analyzed to generate flicker value 32a constitute a first set of frame data. The flicker value generated in response to the first set of frame data is stored for accumulation with other flicker values to be calculated.

Following the storage of an additional sixteen frames of video data, flicker value 32b is subsequently calculated with respect to the most recent sixteen frames of frame buffer set 30b, as well as the previous forty-eight frames of data. These sixty-four frames of data, including forty-eight frames of data previously used to calculate a flicker value, constitute a second set of frame data. In this example, the same process is performed for each additional sixteen frames of data stored by frame buffer 30 until eight flicker values have been calculated. Each resulting flicker value is stored, and the individual flicker features are accumulated at step 34a (for instance, by flicker feature accumulator 22 described with respect to FIG. 1) to generate an accumulated flicker feature. The accumulated flicker feature represents the accumulation of flicker values generated with respect to a plurality of frame data sets, in this example, frame data sets associated with buffer region 30b. Accumulated flicker feature 34a is used to identify a flicker mask, and the results are classified at step 36a to determine whether the flicker mask generated with respect to frame buffer region 30b indicates the presence of fire.

The same procedure is performed with respect to subsequent buffers of frame data, as indicated by the calculation of flicker values 32c, 32d, etc., the accumulation of flicker values at step 34b, and the classifying of the results at step 36b. Typically, there is no need to re-initialize the system. After calculating an accumulated flicker feature with respect to a first buffer (i.e., buffer region 30b), subsequent calculations of flicker features may be based on frame data that overlaps with the previous buffer of frame data. For instance, flicker features calculated with respect to frame buffer 30c includes, initially, frame data from frame buffer 30b.

The graphical illustration shown in FIG. 2 illustrates one of the differences between the present invention and prior art methods of detecting fire based on flicker features. In particular, the present invention relies on the accumulation of flicker data. That is, the system does not make a determination regarding the presence of fire until the flicker features for successive sets of frame data have been analyzed and accumulated to generate the accumulated flicker feature. In addition, in an exemplary embodiment, the present invention does not rely on any additional features to identify the presence of fire. The present invention does not rely on the ability to detect the state or non-turbulent core of the fire, instead relying on the ability to accurately detect the dynamic portion of the fire based on the accumulated flicker value.

In the embodiments shown in FIGS. 1 and 2, video recognition system 14 executes the functions illustrated to generate a determination of whether the video data indicates the presence of fire. Thus, the disclosed invention can be embodied in the form of computer or controller implemented processes and apparatuses for practicing those processes. The present invention can also be embodied in the form of computer program code containing instructions embodied in a computer readable medium, such as floppy diskettes, CD-ROMs, hard drives, or any other computer-readable storage medium, wherein, when the computer program code is loaded into and executed by a processor employed in video recognition system 14, the video recognition system becomes an apparatus for practicing the invention. The present invention may also be embodied in the form of computer program code as a data signal, for example, whether stored in a storage medium, loaded into and/or executed by a computer or video recognition system 14, or transmitted over some transmission medium, such as over electrical wiring or cabling, through fiber optics, or via electromagnetic radiation, wherein, when the computer program code is loaded into and executed by a computer or video recognition system, the computer or video recognition system 14 becomes an apparatus for practicing the invention. When implemented on a general-purpose microprocessor, the computer program code segments configure the microprocessor to create specific logic circuits.

For example, in an embodiment shown in FIG. 1, memory included within video recognition system 14 may store program code or instructions describing the functions shown in FIG. 1. The computer program code is communicated to a processor included within video recognition system 14, which executes the program code to implement the algorithm described with respect to the present invention (e.g., executing those functions described with respect to FIG. 1).

Although the present invention has been described with reference to preferred embodiments, workers skilled in the art will recognize that changes may be made in form and detail without departing from the spirit and scope of the invention. For example, although a video recognition system including a processor and memory was described for implementing the function described with respect to FIG. 1, any number of suitable combinations of hardware and software may be employed for executing the mathematical functions employed by the video recognition system.

Furthermore, throughout the specification and claims, the use of the term ‘a’ should not be interpreted to mean “only one”, but rather should be interpreted broadly as meaning “one or more”. The use of the term “or” should be interpreted as being inclusive unless otherwise stated.

1. A method of detecting fire using video analysis, the method comprising:
acquiring video data comprised of individual frames and organized into a plurality of frame data sets;
calculating a plurality of flicker features corresponding to each of the plurality of frame data sets;
combining the plurality of flicker features to generate an accumulated flicker feature;
defining a flicker mask based on the accumulated flicker feature, the flicker mask representing a dynamic region of the fire;
determining the presence of fire in the acquired video data based on the defined flicker mask; and
generating an output based on the resulting determination of whether the acquired video data is indicative of the presence of fire.

2. The method of claim 1, wherein combining the plurality of flicker features includes applying a logical ‘OR’ operation to each of the plurality of flicker features.

3. The method of claim 1, wherein combining the plurality of flicker feature includes summing each of the plurality of flicker features.

4. The method of claim 1, further including:
defining a static region based on a boundary associated with the defined flicker mask.

5. The method of claim 4, wherein determining the presence of fire includes analyzing the relationship between the geometry of the static region and the geometry of the dynamic region as defined by the flicker mask.

6. The method of claim 1, wherein the plurality of frame data sets includes a first set of frame data and a second set of frame data, wherein video frames included within the first set of frame data are included in the second set of frame data.

7. A video recognition system comprising:
a frame buffer operably connectable to receive video data comprised of a plurality of individual frames and to store the received video data;
a flicker feature calculator that calculates a plurality of flicker features, each flicker feature associated with one of a plurality of frame data sets;
a flicker feature accumulator that combines the plurality of flicker features calculated with respect to each of the plurality of frame data sets to generate an accumulated flicker feature;
a flicker mask generator that defines a flicker mask based on the accumulated flicker feature, wherein the flicker mask represents a dynamic portion of a potential fire; and
decisional logic that determines based on the defined flicker mask whether the video data is indicative of fire and generates an output to that effect.

8. The video recognition system of claim 7, wherein the flicker feature calculator calculates the plurality of flicker features using one of the following algorithms: a Discrete Fourier Transform (DFT), an incremental DFT, a Fast Fourier Transform (FFT), a Wavelet Transform, a Mean Crossing Rate (MCR), a Discrete Cosine Transform (DCT), an incremental DCT, a Fast Cosine Transform (FCT), a Discrete Sine Transform (DST), an incremental DST, and a Fast Sine Transform (FST).

9. The system of claim 7, wherein the plurality of frame data sets includes a first set of frame data and a second set of frame data, wherein video frames included within the first set of frame data are included in the second set of frame data.

10. The system of claim 7, wherein the flicker mask generator defines a static region based on a boundary of the flicker mask.

11. The system of claim 10, wherein the decisional logic detects the presence of fire based on a relationship between the static region and the dynamic region, as defined by the flicker mask.

12. The system of claim 7, wherein the decisional logic employs one of the following means for determining whether the defined flicker mask indicates the presence of fire: a learned model, a support vector machine (SVM), a neural net, a Bayesian classifier, a statistical hypothesis test, and a fuzzy logic classifier.

13. A system for detecting the presence of fire based on video analysis, the system comprising:
means for acquiring video data comprised of individual frames and organized into a plurality of frame data sets, each frame comprised of a plurality of pixels;
means for storing the acquired video as a plurality of frame data sets;
means for calculating a plurality of flicker features corresponding to pixels in each of the plurality of frame data sets;
means for combining the plurality of flicker features calculated with respect to each of the plurality of frame data sets to generate an accumulated flicker feature;
means for defining a flicker mask based on the accumulated flicker feature, the flicker mask representing a dynamic region of the fire;
means for determining the presence of fire in the acquired video data based on the defined flicker mask; and
means for generating an output based on the resulting determination of whether the acquired video data is indicative of the presence of fire.

14. The system of claim 13, further including:
means for defining a static region based on a boundary associated with the defined flicker mask.

15. The system of claim 14, wherein the means for determining the presence of fire includes means for analyzing the relationship between the geometry of the static region and the geometry of the dynamic region as defined by the flicker mask.

16. The system of claim 13, wherein the plurality of frame data sets includes a first set of frame data and a second set of frame data, wherein video frames included within the first set of frame data are included in the second set of frame data.

17. A computer readable storage medium encoded with a machine-readable computer program code for generating a fire detection output, the computer readable storage medium including instructions for causing a controller to implement a method comprising:
acquiring video data comprised of individual frames, each frame comprised of a plurality of pixels;
organizing the individual frames into a plurality of frame data sets;
calculating a plurality of flicker features for each of the plurality of frame data sets;
combining the plurality of flicker features calculated with respect to each of the plurality of frame data sets to generate an accumulated flicker feature for each pixel in the acquired video data;
defining a flicker mask based on the accumulated flicker feature, the flicker mask representing a dynamic region of the fire;
determining the presence of fire in the acquired video data based on the defined flicker mask; and
generating an output based on the resulting determination of whether the acquired video data is indicative of the presence of fire.
